(19) United States
(12) Patent Application Publication
(10) Pub. No.: US 2024/0036581 A1
(43) Pub. Date: Feb. 1, 2024

(54) MOTION LEARNING APPARATUS, MOTION LEARNING METHOD, MOTION ESTIMATION APPARATUS, MOTION ESTIMATION METHOD, AND COMPUTER-READABLE RECORDING MEDIUM

(71) Applicant: NEC Corporation, Minato-ku, Tokyo (JP)

(72) Inventor: Hiroaki Inotsume, Tokyo (JP)

(73) Assignee: NEC Corporation, Minato-ku, Tokyo (JP)

(21) Appl. No.: 18/020,552

(22) PCT Filed: Aug. 14, 2020
(86) PCT No.: PCT/JP2020/030831

§ 371 Date: Feb. 9, 2023

(51) Int. Cl. G05D 1/02; G05D 1/00

(52) U.S. Cl. CPC G05D 1/0221; G05D 1/0044

(57) ABSTRACT

A motion learning apparatus includes: a motion analyzing unit configured to analyze motion of a mobile object based on mobile object state data, and generating motion analysis data; and a learning unit configured to learn a model for estimating the motion of the mobile object in a first environment, using first motion analysis data generated in the first environment and second motion analysis data generated in respective second environments, and furthermore, a motion estimation apparatus includes: an environment analyzing unit configured to analyzing a first environment based on environment state data indicating a state of the first environment, and generating environment analysis data, and an estimation unit configured to estimate motion of a mobile object in the first environment by inputting the environment analysis data to a model.

### TECHNICAL FIELD

The present invention relates to a motion learning apparatus, a motion learning method, a motion estimation apparatus, and a motion estimation method that are used to estimate motion of a mobile object, and further relates to a computer-readable recording medium having recorded thereon a program for realizing the apparatuses and methods.

### BACKGROUND ART

Recently, natural disasters frequently occur, and people have to work in dangerous environments in disaster-stricken areas. In view of this, efforts have been taken to autonomize work vehicles and the like used in such dangerous environments.

In dangerous environments such as disaster-stricken areas, however, it is difficult to accurately estimate motion of work vehicles. In other words, it is difficult to make work vehicles to autonomously travel, perform work, and the like in correspondence with the dangerous environments.

The reason for that is because it is difficult to obtain, in advance, data regarding dangerous environments such as disaster-stricken areas, in other words, unknown environments such as irregular outdoor terrain that is not maintained.

As a related technology, Patent Document 1 discloses a method in which measured data is analyzed using a pattern recognition algorithm, data resulting from the analysis is compared to a plurality of patterns stored in a database, and a pattern that matches the data is selected.

Also, as another related technology, Patent Document 2 discloses that if an event and an event location detected when a vehicle travels on the same route for the second time match a specified event location that is already stored, the vehicle is make to start an action related to that event location.

### LIST OF RELATED ART DOCUMENTS

### Patent Documents

Patent Document 1: Japanese Patent Laid-Open Publication No. 2016-528569
Patent Document 2: Japanese Patent Laid-Open Publication No. 2018-504303

### SUMMARY

### Technical Problems

However, with the methods disclosed in Patent Documents 1 and 2, motion of a work vehicle in an unknown environment cannot be accurately estimated. In other words, as described above, since it is difficult to obtain data regarding an unknown environment in advance, motion of a work vehicle cannot be accurately estimated even if the methods disclosed in Patent Documents 1 and 2 are used.

An example object is to provide a motion learning apparatus, a motion learning method,
a motion estimation apparatus, a motion estimation method and a computer-readable recording medium that are used to accurately estimate motion of a mobile object in an unknown environment.

### Solution to the Problems

In order to achieve the example object described above, a motion learning apparatus according to an example aspect includes:
a motion analyzing unit configured to analyze motion of a mobile object based on mobile object state data indicating a state of the mobile object, and generating motion analysis data indicating the motion of the mobile object; and
a learning unit configured to learn a model for estimating the motion of the mobile object in a first environment, using first motion analysis data generated in the first environment and second motion analysis data generated in respective second environments.

Also, in order to achieve the example object described above, a motion learning apparatus according to an example aspect includes:
an environment analyzing unit configured to analyze a first environment based on environment state data indicating a state of the first environment, and generating environment analysis data, and
an estimation unit configured to estimate motion of a mobile object in the first environment by inputting the environment analysis data to a model for estimating the motion of the mobile object in the first environment.

Also, in order to achieve the example object described above, a motion learning method according to an example aspect includes:
analyzing motion of a mobile object based on mobile object state data indicating a state of the mobile object and generating motion analysis data indicating the motion of the mobile object; and
learning a model for estimating the motion of the mobile object in a first environment, using first motion analysis data generated in the first environment and second motion analysis data generated in respective second environments.

Also, in order to achieve the example object described above, a motion learning method according to an example aspect includes:
analyzing a first environment based on environment state data indicating a state of the first environment, and generating environment analysis data, and
estimating motion of a mobile object in the first environment by inputting the environment analysis data to a model for estimating the motion of the mobile object in the first environment.

Also, in order to achieve the example object described above, a computer-readable recording medium according to an example aspect includes a program recorded on the computer-readable recording medium, the program including instructions that cause the computer to carry out:
analyzing motion of a mobile object based on mobile object state data indicating a state of the mobile object and generating motion analysis data indicating the motion of the mobile object; and
learning a model for estimating the motion of the mobile object in a first environment, using first motion analysis data generated in the first environment and second motion analysis data generated in respective second environments.

Furthermore, in order to achieve the example object described above, a computer-readable recording medium according to an example aspect includes a program recorded on the computer-readable recording medium, the program including instructions that cause the computer to carry out:
analyzing a first environment based on environment state data indicating a state of the first environment, and generating environment analysis data, and
estimating motion of a mobile object in the first environment by inputting the environment analysis data to a model for estimating the motion of the mobile object in the first environment.

### Advantageous Effects of the Invention

As an example aspect, it is possible to accurately estimate motion of a mobile object in an unknown environment.

### BRIEF DESCRIPTION OF THE DRAWINGS

FIG. 1 is a diagram illustrating a relationship between an inclination angle and slippage in an unknown environment.

FIG. 2 is a diagram illustrating estimation of slippage on a steep slope in an unknown environment.

FIG. 3 is a diagram illustrating an example of the motion learning apparatus.

FIG. 4 is a diagram illustrating an example of a motion estimation apparatus.

FIG. 5 is a diagram illustrating an example of the system.

FIG. 6 is a diagram illustrating one example of information regarding the topographic shape.

FIG. 7 is a diagram illustrating the relationship between the grid cells and the slippage.

FIG. 8 is a diagram illustrating the relationship between the grid cells and whether each grid cell is passable or impassable.

FIG. 9 is a diagram illustrating the system of Example 2.

FIG. 10 is a diagram illustrating an example of a path.

FIG. 11 is a diagram illustrating one example of a path.

FIG. 12 is a diagram illustrating an example of the operations of the motion learning apparatus.

FIG. 13 is a diagram illustrating an example of the operations of the motion estimation apparatus.

FIG. 14 is a diagram illustrating an example of the operations of the system of Example 1.

FIG. 15 is a diagram illustrating an example of the operations of the system of Example 2.

FIG. 16 is a diagram illustrating an example of a computer that realizes the motion learning apparatus.

### EXAMPLE EMBODIMENTS

First, an outline will be described for facilitating understanding of the example embodiments described below.

Conventionally, an autonomous work vehicle that operates in unknown environments such as disaster-stricken areas, construction sites, mountain forests, and other planets, obtains image data obtained by capturing images of the unknown environment from an image capturing device mounted in the work vehicle, performs image processing on the obtained image data, and estimates the state of the unknown environment based on the result of the image processing.

However, the state of the unknown environment cannot be accurately estimated only from the image data. For this reason, it is difficult to estimate motion of a work vehicle, and make a work vehicle to travel and operate in unknown environments.

Here, “the state of the unknown environment” means the state of an environment in which the topography, the type of ground, the state of the ground and the like are unknown, for example. “The type of ground” means, for example, the type of soil categorized by content ratio of gravel, sand, clay, silt, and the like. Also, “the type of ground” may include ground where plants grow, ground made of concrete, rock, or the like, and ground where obstacles are present, for example.

“The state of the ground” means, for example, the moisture content of the ground, the looseness (solidness) of the ground, the geological formation, and the like.

Also, in recent years, it has been proposed that image data captured in the past in various environments is set to training data, a model for estimating a route on which the vehicle will travel is learned, and the route on which the vehicle will travel is estimated using the learned model.

However, the training data lacks image data of the unknown environment and data regarding topography which is highly risky for the work vehicle, such as steep slopes or pooled water. Accordingly, learning of the model is insufficient. For this reason, if the model which is insufficiently learned is used, it is difficult to accurately estimate travel of the work vehicle.

Through such processes, the inventors found a problem that motion of a vehicle cannot be accurately estimated in an unknown environment by methods such as described above. In addition, the inventors have found a means to solve the problem.

In other words, the inventors derived a means for accurately estimating motion of a mobile object such as a vehicle in an unknown environment. As a result, since motion of a mobile object such as a vehicle can be accurately estimated, a mobile object can be accurately controlled even in an unknown environment.

Hereinafter, estimation of motion of a mobile object will be described with reference to the drawings. In the drawings described below, elements having identical or corresponding functions will be assigned the same reference signs, and redundant descriptions thereof may be omitted.

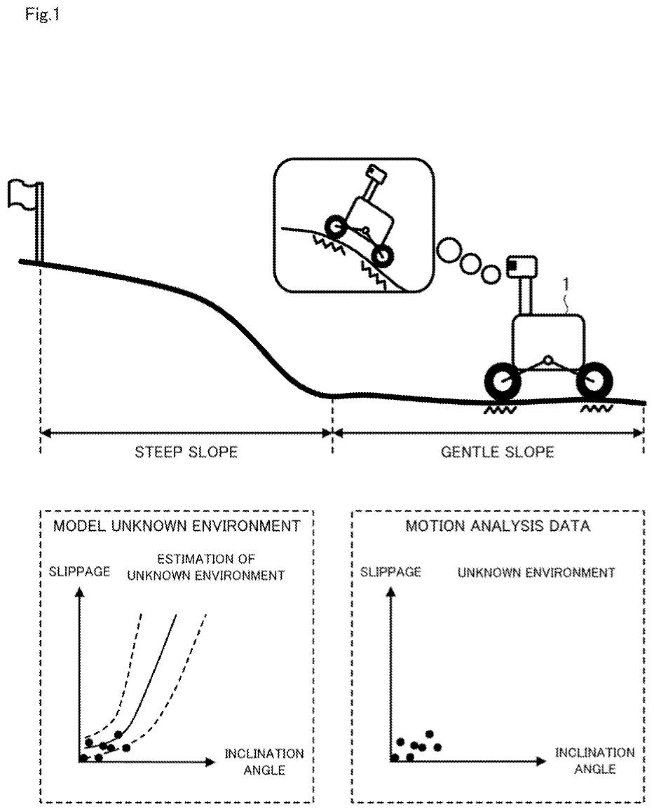

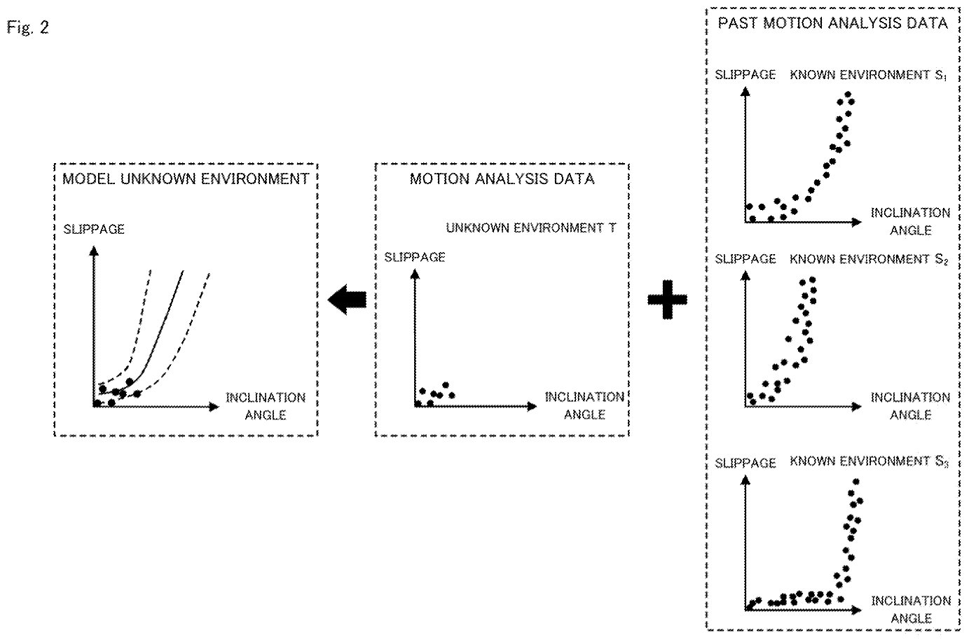

Estimation of motion of a mobile object (slippage of a work vehicle 1) will be described using FIGS. 1 and 2. FIG. 1 is a diagram illustrating a relationship between an inclination angle and slippage in an unknown environment. FIG. 2 is a diagram illustrating estimation of slippage on a steep slope in an unknown environment.

First, a work vehicle 1, which is a mobile object shown in FIG. 1, obtains mobile object state data indicating the state of the mobile object from sensors for measuring the state of the work vehicle 1 while traveling in an unknown environment, and stores the obtained mobile object state data in a storage device provided inside or outside of the work vehicle 1.

Next, the work vehicle 1 analyzes the mobile object state data obtained from the sensors, in a gentle slope with a low risk in the unknown environment, to obtain motion analysis data indicating a relationship between the inclination angle of the gentle slope and slippage of the work vehicle 1. Graphs in FIGS. 1 and 2 illustrate images of motion analysis data.

Next, the work vehicle 1 learns a model regarding the slippage on a steep slope in order to estimate the slippage of the work vehicle 1 on the steep slope shown in FIG. 1. Specifically, the work vehicle 1 learns a model for estimating slippage of the work vehicle 1 using the motion analysis data on a gentle slope with a low risk in the unknown environment, and a plurality of pieces of past motion analysis data.

The plurality of pieces of past motion analysis data can be represented with an image as in the graphs in FIG. 2. For example, if the known environments are S₁ (cohesive soil), S₂ (sandy soil), and S₃ (rock), the plurality of pieces of past motion analysis data are data indicating the relationship between the inclination angle and the slippage, that is generated by analyzing the mobile object state data in the respective environments. Note that, the plurality of pieces of past motion analysis data are stored in the storage device.

In the example shown in FIG. 2, the work vehicle 1 learns a model using the motion analysis data generated based on the mobile object state data measured on a gentle slope in an unknown environment and the past motion analyzing data generated in the respective known environments S₁, S₂, and S₃.

Next, slippage of the work vehicle on a steep slope in an unknown environment is estimated using the learned model. Specifically, on the gentle slope with a low risk in the unknown environment, the work vehicle 1 analyzes the environment state data indicating the state of the steep slope obtained by the work vehicle 1 from the sensors to generate environment analysis data indicating topographic shape and the like.

Next, the work vehicle 1 inputs the environment analysis data to a model for estimating the motion of the mobile object in the target environment to estimate the slippage of the work vehicle 1 on the steep slope in the target environment.

By doing so, motion of a mobile object can be accurately estimated in an unknown environment. Accordingly, a mobile object can be accurately controlled even in an unknown environment.

### Example Embodiment

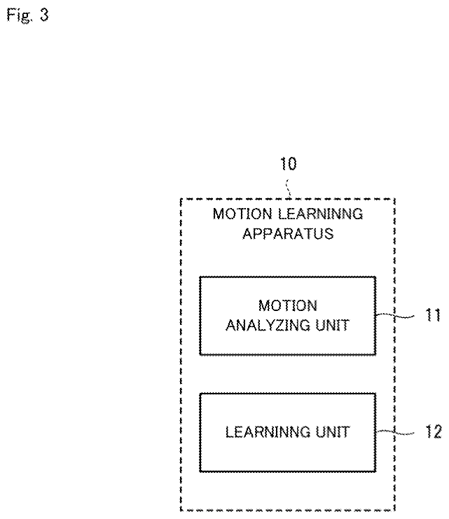

Hereinafter, an example embodiment will be described with reference to the drawings. The configuration of a motion learning apparatus 10 in the example embodiment will be described using FIG. 3. FIG. 3 is a diagram illustrating an example of the motion learning apparatus.

### Configuration of Motion Learning Apparatus

The motion learning apparatus 10 shown in FIG. 3 is an apparatus for learning a model used for accurately estimating the motion of a mobile object in an unknown environment. As shown in FIG. 3, the motion learning apparatus 10 includes a motion analyzing unit 11 and a learning unit 12.

The motion learning apparatus 10 is a circuit or an information processing apparatus on which a CPU (Central Processing Unit), an FPGA (Field-Programmable Gate Array), a GPU (Graphics Processing Unit) is mounted, or on which all thereof or two or more thereof are mounted, for example.

The motion analyzing unit 11 analyzes motion of the mobile object based on the mobile object state data indicating the state of the mobile object to generate the motion analysis data indicating motion of a mobile object.

The mobile object is, for example, a vehicle, a ship, an aircraft, a robot, or the like that is autonomous. If the mobile object is a work vehicle, the work vehicle is a construction vehicle used for operation in a disaster-stricken area, a construction site or a mountain forest, an exploration vehicle used for exploration in a planet, or the like.

The mobile object state data is data indicating the state of a mobile object obtained from a plurality of sensors for measuring the state of the mobile object. If the mobile object is a vehicle, the sensors for measuring the state of the mobile object are, for example, positional sensors for measuring the position of the vehicle, IMUs (Inertial Measurement Units: triaxial gyrosensor plus triaxial angular velocity sensor), wheel encoders, measurement instruments for measuring power consumption or fuel consumption, or the like.

The motion analysis data is data indicating the moving speed, the attitude angle, and the like of a mobile object, generated using the mobile object state data. If the mobile object is a vehicle, the motion analysis data is data indicating, for example, the traveling speed, wheel rotation speed, and attitude angle of the vehicle, slippage during traveling, vibration of the vehicle while traveling, the power consumption, the fuel consumption, and the like.

The learning unit 12 uses the motion analysis data (first motion analysis data) generated in the target environment (first environment) and the motion analysis data (second motion analysis data) generated in respective known environments (second environments) in the past, to calculate the similarity between the target environment and the known environments. Next, the learning unit 12 uses the calculated similarity and the models learned in the respective known environments, to learn a model for estimating the motion of the mobile object in the target environment.

The target environment is an unknown environment where the mobile object travels in a disaster-stricken area, a construction site, a mountain forest, or a planet, for example.

The model is a model used for estimating the motion of the mobile object such as the work vehicle 1 in an unknown environment. The model can be represented by a function as shown in Expression 1.

[Expression 1]

f^{(T)}(x*|D, θ)=f^{(S}^{_{i,}}^{T)}(x*|D^{(T)}, D^{(S}^{ᵢ}⁾, θ^{(T)}, θ^{(S}^{ᵢ}⁾) (1)
D={D^{(T)}, D^{(S}^{₁}⁾, . . . D^{(S}^{_{N}}⁾}
θ={θ^{(T)}, θ^{(S}^{₁}⁾, . . . θ^{(S}^{_{N}}⁾}
D^{(T)}={Xⱼ^{(T)}, Yⱼ^{(T)}}
D^{(S}^{ᵢ}⁾={Xⱼ^{(S}^{ᵢ}⁾, Yⱼ^{(S}^{ᵢ}⁾}
θ^{(T)}={θ₁^{(T)}, . . . , θ_{P}^{(T)}}
θ^{(S}^{ᵢ}⁾={θ₁^{(S}^{₁}⁾, . . . , θ_{P}^{(S}^{ᵢ}⁾}
T: symbol representing the target environment (unknown environment) (target domain)
Sᵢ: symbol representing the i-th known environment (source domain)
i: 1 to N (integer of 2 or more)
f: model
x*: estimated point
x: input (feature amount)
D: motion analysis data of target environment and known environment
D^{(T)}: set of motion analysis data in the target environment
D^{(Si)}: set of motion analysis data in i-th known environment
X: set of input values x in motion analysis data, for example, set of inclination angles
Y: set of observed values y in the motion analysis data, for example, set of slippage values
j: 1 to M (integer of 2 or more)
θ: vector composed of P model parameters and hyperparameters
θ^{(T)}: vector composed of model parameters and hyperparameters for the target environment
θ^{(S}^{ᵢ}⁾: vector composed of model parameters and hyperparameters for the i-th known environment

The Gaussian process regression model represented by Expression 2 is an example of a model to which Expression 1 is applied. The Gaussian process regression model constructs a model based on the motion analysis data. Also, the Gaussian process regression model learns a weight wᵢ shown in Expression 2. The weight wᵢ is a model parameter indicating the similarity between the motion analysis data corresponding to the target environment and the motion analysis data corresponding to a known environment.

$$\begin{matrix}[ Expression 2 ] & \\ {f}^{( T )} ( {x}^{*} \vert D , θ ) = {\sum }_{i = 1}^{N} g ( {w}_{i} ) \cdot {f}^{( {S}_{i} )} ( {x}^{*} \vert {D}^{( T )} , {D}^{( {S}_{i} )} , {θ}^{( T )} , {θ}^{( {S}_{i} )} ) & ( 2 )\end{matrix}$$

wᵢ: similarity between motion analysis data of the target environment and motion analysis data of the i-th known environment
g: any function monotonic on wᵢ
f^{(S}^{ᵢ}⁾: function that changes according to motion analysis data corresponding to the target environment

Further, the linear regression model represented by Expression 3 is an example of another model. The linear regression model constructs a model based on a learned model generated for each of the plurality of known environments in the past.

$$\begin{matrix}[ Expression 3 ] & \\ {f}^{( T )} ( {x}^{*} \vert D , θ ) = {\sum }_{i = 1}^{N} g ( {w}_{i} ) \cdot {f}^{( {S}_{i} )} ( {x}^{*} \vert {θ}^{( {S}_{i} )} ) & ( 3 )\end{matrix}$$

f^{(S}^{ᵢ}⁾: function that does not change with motional analysis data corresponding to the target environment

### Configuration of Motion Estimation Apparatus

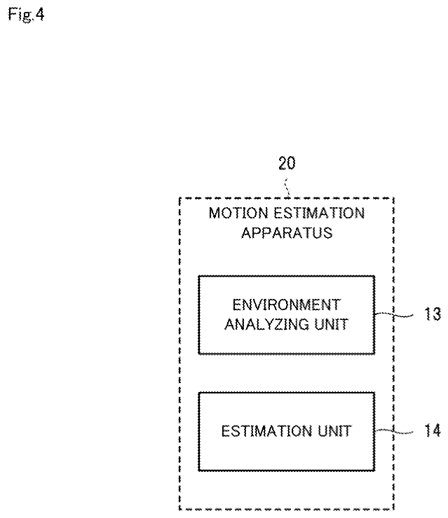

Next, the configuration of a motion estimation apparatus 20 according to the example embodiment will be described using FIG. 4. FIG. 4 is a diagram illustrating an example of a motion estimation apparatus.

The motion estimation apparatus 20 shown in FIG. 4 is an apparatus for accurately estimating motion of a mobile object in an unknown environment. As shown in FIG. 4, the motion estimation apparatus 20 includes an environment analyzing unit 13 and an estimation unit 14.

The motion estimation apparatus 20 is a circuit or an information processing apparatus on which a CPU, an FPGA or an GPU is mounted, or on which all thereof, or two or more thereof are mounted, for example.

The environment analyzing unit 13 analyzes the target environment based on the environment state data indicating the state of the target environment to generate the environment analysis data.

The environment state data is data indicating the state of the target environment, obtained from the plurality of sensors for measuring the state of the surrounding environment (target environment) of the mobile object. If the mobile object is a vehicle, the sensors for measuring the state of the target environment are LiDARs (Light Detection and Ranging, Laser Imaging Detection and Ranging), image capturing devices, or the like, for example.

The LiDARs generate three-dimensional point cloud data of the surroundings of the vehicle, for example. The image capturing devices are, for example, cameras for capturing images of the target environment, and output image data (moving images or still images). Also, the sensors for measuring the state of the target environment may be sensors provided outside of the mobile object, for example, sensors provided in aircrafts, drones, artificial satellites, or the like.

The environment analysis data is data that indicates the state of the target environment, and is generated using the environment state data. If the mobile object is a vehicle, the environment state data is, for example, data indicating the topographic shape such as inclination angles and unevenness. Note that three-dimensional point cloud data, image data, three-dimensional map data or the like may be used as the environment state data.

The estimation unit 14 inputs the environment analysis data to a model for estimating motion of the mobile object in the target environment, to estimate the motion of the mobile object in the target environment.

The model is a model for estimating motion of a mobile object such as the work vehicle 1 in an unknown environment, generated by the above-described learning unit 12. The model is a model as represented by Expressions 2 and 3.

### System Configuration

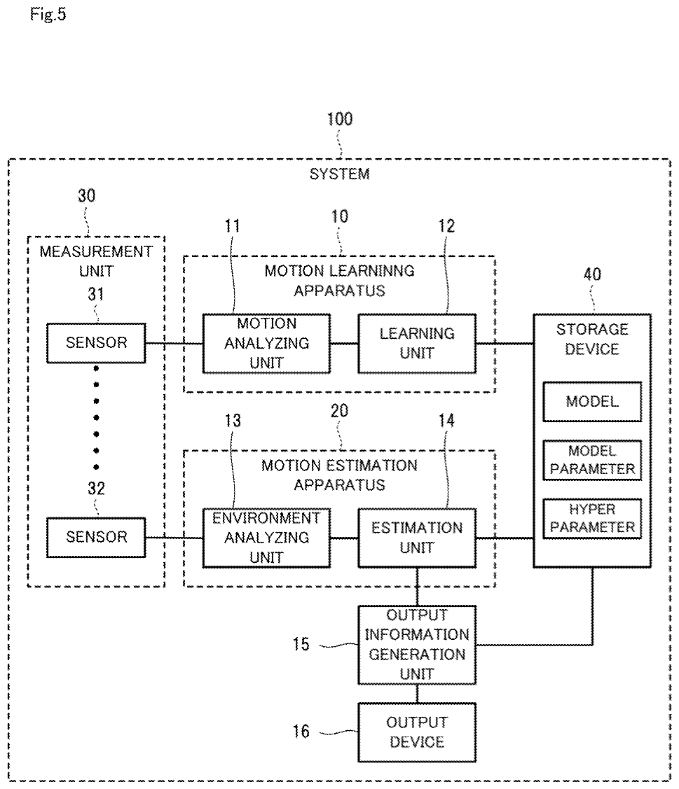

Next, the configuration of a system 100 mounted in the mobile object according to the example embodiment will be described using FIG. 5. FIG. 5 is a diagram illustrating an example of the system.

As shown in FIG. 5, the system 100 in the example embodiment includes the motion learning apparatus 10, the motion estimation apparatus 20, a measurement unit 30, the storage device 40, an output information generation unit 15, and an output device 16.

The measurement unit 30 includes sensors 31 and sensors 32. The sensors 31 are sensors for measuring the state of the above-described mobile object. The sensors 32 are sensors for measuring the state of the surrounding environment (target environment) of the above-described mobile object.

The sensors 31 measure the state of the mobile object and output the measured mobile object state data to the motion analyzing unit 11. The sensors 31 include a plurality of sensors. If the mobile object is a vehicle, the sensors 31 are, for example, positional sensors for measuring the position of the vehicle, IMUs, wheel encoders, measurement instruments for measuring power consumption or fuel consumption, or the like. The positional sensors are, for example, GPS (Global Positioning System) receivers. The IMUs measure the acceleration of the vehicle in the triaxial (XYZ axes) directions and the triaxial angular velocity of the vehicle. The wheel encoders measure the rotational speed of the wheels.

The sensors 32 measure the state of the surrounding environment (target environment) of the mobile object and output the measured environment state data to the environment analyzing unit 13. The sensors 32 include a plurality of sensors. If the mobile object is a vehicle, the sensors 32 are, for example, LiDARs, image capturing devices, and the like. Also, the sensors for measuring the state of the target environment may be sensors provided outside of the mobile object, for example, sensors provided in aircrafts, drones, artificial satellites, or the like.

First, the motion analyzing unit 11 obtains the mobile object state data measured by each of the sensors included in the sensors 31 in the target environment. Next, the motion analyzing unit 11 analyzes the obtained mobile object state data to generate first motion analysis data indicating the motion of the mobile object. Next, the motion analyzing unit 11 outputs the generated first motion analysis data to the learning unit 12.

First, the learning unit 12 obtains the first motion analysis data that is output from the motion analyzing unit 11 and second motion analyzing data that is generated in the respective known environments and stored in the storage device 40. Next, the learning unit 12 learns the model indicated in Expressions 2, 3, and the like, using the obtained first motion analysis data and the second motion analysis data. Next, the learning unit 12 stores a model parameter generated through the learning, in the storage device 40.

First, the environment analyzing unit 13 obtains the environment state data measured by each of the sensors included in the sensors 32 in the target environment. Next, the environment analyzing unit 13 analyzes the obtained environment state data to generate the environment analysis data indicating the state of the environment. Next, the environment analyzing unit 13 outputs the generated environment analysis data to the estimation unit 14. Also, the environment analyzing unit 13 may store the environment analysis data in the storage device 40.

First, the estimation unit 14 obtains the environment analyzing data that is output from the environment analyzing unit 13, the model parameters, the hyperparameters, and the like stored in the storage device 40. Next, the estimation unit 14 inputs the obtained environment analysis data, model parameters, hyperparameters and the like, to the model for estimating the motion of the mobile object in the target environment, to estimate the motion of the mobile object in the target environment. Next, the estimation unit 14 outputs the result (motion estimation result data) of estimation of the motion of the mobile object to the output information generation unit 15. Also, the estimation unit 14 stores the motion estimation result data to the storage device 40.

The storage device 40 is a memory that stores various kinds of data handled in the system 100. In the example shown in FIG. 5, the storage device 40 is mounted in the system 100, but the storage device 40 may be mounted separately from the system 100. In that case, the storage device 40 may conceivably be a storage device such as database, a server computer, or the like.

First, the output information generation unit 15 obtains the motion estimation result data that is output from the estimation unit 14 and the environment state data from the storage device 40. Next, the output information generation unit 15 generates output information for outputting to the output device 16 based on the motion estimation result data and the environment state data.

The output information is information used to display the images and map of the target environment on a monitor of the output device 16. Also, the motion of the mobile object, the risk of the target environment, whether it is possible for the mobile object to move, and the like may be displayed based on the motion estimation result data, on the images and map of the target environment.

Note that the output information generation unit 15 may also be provided inside the motion estimation apparatus 20.

The output device 16 obtains the output information generated by the output information generation unit 15, and outputs the images, audio and the like, based on the obtained output information. The output device 16 is, for example, an image display device in which liquid crystals, an organic EL (Electro Luminescence), or CRTs (Cathode Ray Tubes) are used. Further, the image display device may include the audio output device such as a speaker. Note that the output device 16 may be a printing device such as a printer. Also, the output device 16 may be provided in a mobile object, or at a remote place, for example.

### EXAMPLE 1

The motion learning apparatus 10 and the motion estimation apparatus 20 will be specifically described. Example 1 describes a case where slippage (motion) of the work vehicle 1 while traveling on a slope in an unknown environment is estimated from data obtained while traveling a gentle slope. In Example 1, since the slippage is estimated, the slippage is modeled as a function relating to the topographic shape (inclination angle, unevenness) of the target environment.

### Learning Operation of Example 1

In learning of Example 1, the motion analyzing unit 11 makes the work vehicle 1 to travel on a gently sloping topography with a lower risk in the target environment at a constant speed, and obtains the mobile object state data from the sensors 31 of the measurement unit 30 at a certain interval. The motion analyzing unit 11 obtains the mobile object state data at an interval of every 0.1 second, 0.1 m, or the like.

Next, the motion analyzing unit 11 uses the obtained mobile object state data to calculate moving speeds Vx, Vy, and Vz of the work vehicle 1 in the X, Y, and Z directions, a wheel rotation speed ω of the work vehicle 1, and an attitude angle (roll angle θx, pitch angle θy, yaw angle θz) of the work vehicle 1 around the X, Y, and Z axes.

The moving speeds are calculated by dividing the difference in GPS latitude, longitude, and altitude between two points, by the difference in time between the two points, for example. The attitude angle is calculated by integrating the angular velocity of the IMU, for example.

Note that, the traveling speeds and the attitude angle may also be calculated based on the Kalman filter, using both the mobile object state data measured by the GPS and the mobile object state data measured by the IMU. Alternately, the traveling speeds and the attitude angle may be calculated based on the SLAM (Simultaneous Localization and Mapping: a technique for concurrently performing estimation of the position of the mobile object and construction of the surrounding area map) based on data of the GPS, the IMU, and the LiDAR.

Next, as represented by Expression 4, the motion analyzing unit 11 calculates the slippage based on the traveling speed and wheel rotation speed of the work vehicle 1. Note that the slippage is a continuous value.

[Expression 4]

slip=(rω̅−vₓ)/rω̅ (4)
slip: Slippage
r: Wheel radius
ω̅: Average rotational speed of each wheel
rω̅: vehicle translation speed without slippage (target speed)
vₓ: moving speed in movement direction (X direction)

When the work vehicle 1 is travelling at the same speed as the target speed, slippage=0. Also, when the work vehicle 1 is not travelling at all, slippage=1. Also, when the work vehicle 1 is travelling at a higher speed than the target speed, the slippage is a negative value.

Next, the motion analyzing unit 11 outputs, to the learning unit 12, a plurality of data points (first motion analyzing data) with a roll angle θx, a pitch angle θy, and slippage assumed to be a set of data points.

Next, the learning unit 12 learns a model relating to the roll angle θx, the pitch angle θy, and the slippage, in the target environment, based on the similarly between the data points (first motion analysis data) that are output from the motion analyzing unit 11 and the data points (second motion analysis data) generated in the known environment in the past and stored in the storage device 40.

Alternatively, the learning unit 12 learns a model relating to the roll angle θx, the pitch angle θy, and slippage, in the target environment, based on the similarly between the model generated based on the data points (first motion analysis data) that are output from the motion analyzing unit 11 and the model generated based on the data points (second motion analysis data) generated in the known environment in the past stored in the storage device 40.

As a specific example, an example will be described in which, when the three pieces of known environment data have been obtained as shown in FIG. 2, the Gaussian process regression is applied to f^{(Si)} in Expression 2, and parameters and hyperparameters of f^{(Si)} are learned using the motion analysis data of Sᵢ and the motion analysis data of the target environment.

Likelihood of the motion analysis data in the target environment that is modeled using f^{(Si)} is used for wᵢ of Expression 2. When the models of the known environments are respectively assumed to represent a slippage event in the target environment, likelihood is a probability indicating the degree of likelihood of a data point in the target environment with respect to that model.

g(wᵢ) in Expression 2 is assumed to be wᵢ/Σwᵢ. At this time, if it is assumed that the likelihoods pᵢ of the motion analysis data in the target environment of i=1, 2, and 3 are respectively P₁=0.5, P₂=0.2, and P₃32 0.1, the weights wᵢ respectively satisfy w₁=0.5, w₂=0.2, and w₃=0.1. The total of the weights wᵢ satisfies Σwᵢ=0.5+0.2+0.1=0.8.

Accordingly, g(w₁)=0.5/0.8=0.625, g(w₂)=0.2/0.8=0.25, g(w₃)=0.1/0.8 =0.125. In this manner, the model of f^{(T)} in Expression 2 is constructed as the total of weights f^{(Si)} using g(wᵢ) as the weight.

Also, for example, when the slippage is modeled for each of the known environments using the polynomial regression, the weight wᵢ is determined based on an indicator that indicates the degree to which data in the target environment can be expressed using the model in each of the known environments.

Regarding the weight wᵢ, for example, the inverse number of an error of mean square (MSE) when the slippage in the target environment is estimated using the model in each known environment is set to the weight wᵢ. Alternatively, a determination coefficient (R²) at the time when the slippage in the target environment is estimated using the model in each known environment is set to the weight wᵢ.

Further, for example, in the case where the slippage is modeled using the Gaussian process regression for each known environment, if the Gaussian process regression is used, it is possible to perform not only average estimation but also express the uncertainty of the estimation by probabilistic distribution. In this case, the likelihood of the data in the target environment, when the slippage in the target environment is estimated using the model of each known environment, assuming that the weight is wᵢ, is used.

Note that, regardless of which indicator out of the error of mean square (MSE), the determination coefficient (R²), and the likelihood is used as the similarity, if knowledges with a low similarity are combined, it is highly possible that the estimation accuracy in the target environment will degrade. For this reason, it is also possible to set thresholds in advance for the similarities (1/MSE, R², and likelihood), and to use only the models of the known environments for which the similarity is the threshold or higher. Further, it is also possible to use only the model with the maximum similarity or the models of a predetermined number in descending order of similarity.

Note that, modeling may be performed using methods other than the above-described polynomial regression and Gaussian process regression. Examples of other machine learning methods include a support vector machine and a neural network. Also, modeling may be performed in a white-box manner based on a physical model rather than modeling the relationship between input and output in a black-box manner as in the machine learning method.

Regardless of which of the above-described model methods is used, the model parameters stored in the storage device 40 may also be used as is, or the model parameters may also be re-learned using data obtained while traveling in the target environment.

Also, if knowledges with a low similarity are combined, it is highly possible that the estimation accuracy in the target environment will be degraded. For this reason, it is also possible that thresholds are set in advance for the similarities (1/MSE, R², and likelihood), and only the model of the known environment for which the similarity is the threshold or more is used.

Note that the models in the plurality of known environments that are stored in the storage device 40 may be obtained by learning based on data obtained in the real world, or based on data obtained through physical simulation.

### Estimation Operation in Example 1

In estimation, the work vehicle 1 measures the topographic shape of the land to travel, and estimates the slippage in the target environment based on the learned model.

Specifically, first, the environment analyzing unit 13 obtains the environment state data from the sensors 32 of the measurement unit 30. The environment analyzing unit 13 obtains the three-dimensional point (environment state data) generated by measuring the forward target environment using a LiDAR mounted in the work vehicle 1, for example.

Next, the environment analyzing unit 13 generates topographic shape data (environment analysis data) relating to the topographic shape by processing the three-dimensional point cloud.

Generation of information relating to the topographic shape will be specifically described.

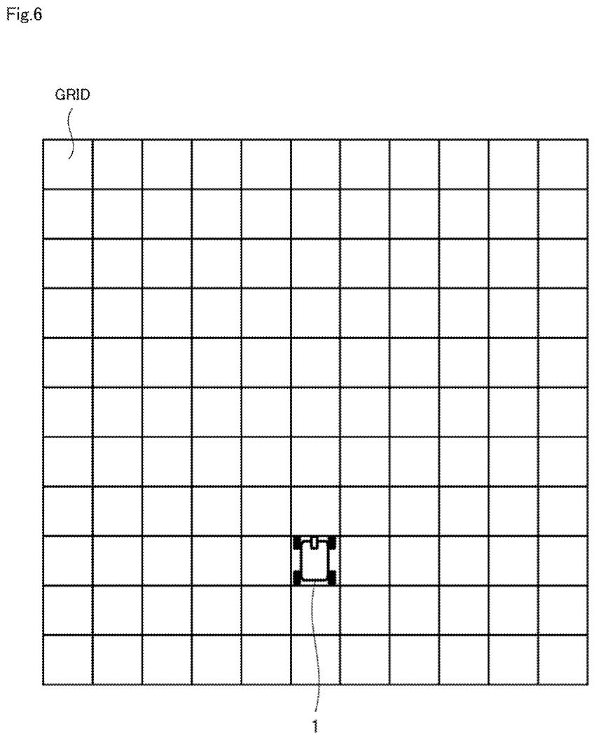

First, as shown in FIG. 6, the environment analyzing unit 13 divides the target environment (space) into a grid, and assigns a point cloud to each grid cell. FIG. 6 is a diagram illustrating one example of information regarding the topographic shape.

Next, the environment analyzing unit 13 calculates, for each grid cell, the approximate plane with which the mean distance error of the point cloud is the minimum, from the point groups included in the grid cell itself and the grid cells in the surrounding eight directions, and calculates the maximum inclination angle and the inclination direction of the approximate plane.

Next, the environment analyzing unit 13 generates, for each grid cell, topographic shape data (environment analysis data) by associating the coordinates representing the position of the grid cell, the maximum inclination angle and the inclination direction of the approximate plane with each other and stores the data in the storage device 40.

Next, the estimation unit 14 estimates the slippage for each grid cell based on the topographic shape data generated by the environment analyzing unit 13 and the learned models of the slippage.

A method for estimating the slippage in each grid cell will be specifically described below. (1) The slippage is estimated by inputting only the maximum inclination angle of the grid cell to the model. Note that, in actuality, the slippage of the work vehicle 1 is determined based on the orientation of the work vehicle 1 with respect to the slope. For example, in the case where the work vehicle 1 faces in the maximum inclination angle direction (the orientation in which the inclination is steepest), the slippage is largest, and thus estimation of the slippage using the maximum inclination angle means performing estimation in a conservative manner. Note that, the slippage may be estimated on the following condition: The pitch angle of the work vehicle 1=the maximum inclination; and the roll angle=0.

(2) The estimation unit 14 estimates the slippage corresponding to the direction in which the work vehicle 1 passes through the grid cell, based on the information about the maximum inclination angle and the slope direction stored in each grid cell. In this case, the roll angle and the pitch angle of the work vehicle 1 are calculated based on the maximum angle, the slope direction, and the traveling direction, of the work vehicle 1. Also, for each grid cell, the slippage is estimated with respect to a plurality of traveling directions (e.g., every 15 degrees) of the work vehicle 1.

(3) In the case where it is possible to express the estimation considering the uncertainty by Gaussian process regression, etc., the mean values and the variances of the slippage are estimated. The motion of the work vehicle 1 becomes complicated on a steep slope and a severely uneven topography. Accordingly, there is a high possibility that variation in the slippage will increase. And thus, estimating the distribution as well as the mean of the slippage makes it further possible to operate the work vehicle 1 safely.

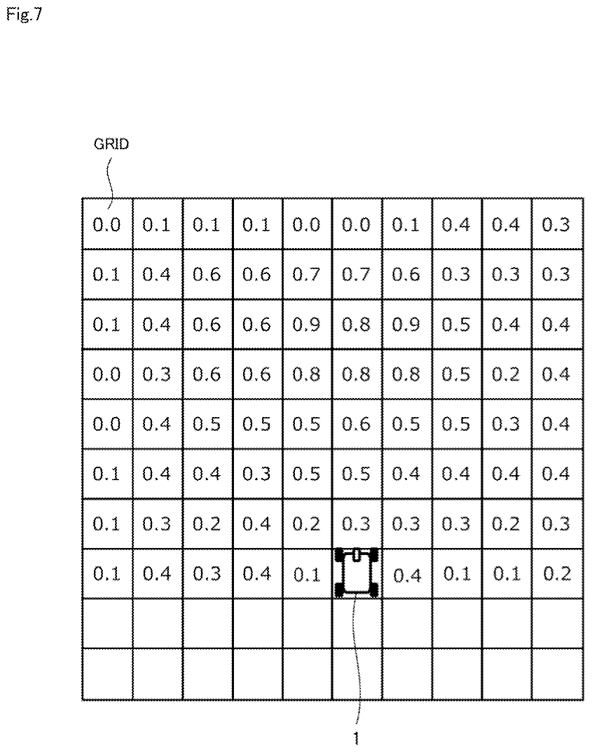

Next, as shown in FIG. 7, the estimation unit 14 generates the motion estimation result data by associating each grid cell with the estimated slippage (continuous value of the slippage in the maximum inclination angle direction) and stores the data in the storage device 40. FIG. 7 is a diagram illustrating the relationship between the grid cells and the slippage.

Alternatively, the estimation unit 14 generates the motion estimation result data by associating each grid cell with the estimated slippage and the vehicle traveling direction, and stores the data in the storage device 40. The vehicle traveling direction is indicated using the angle with respect to a predetermined direction, for example.

Alternatively, the estimation unit 14 generates, the motion estimation result data by associating the respective grid cells with the mean of the estimated slippage, the distribution of the slippage, and the vehicle traveling direction, and stores the data in the storage device 40.

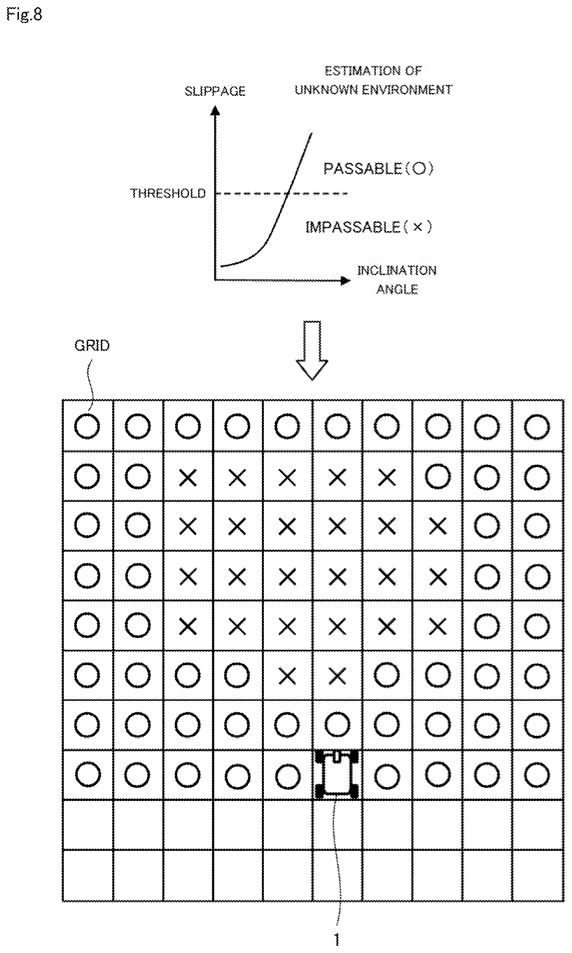

Alternatively, the estimation unit 14 determines whether the grid cell is passable or impassable, based on a predetermined threshold with respect to the slippage, generates the motion estimation result data by associating the information indicating the determination result with the grid cells, and stores the data in the storage device 40. FIG. 8 is a diagram illustrating the relationship between the grid cells and whether each grid cell is passable or impassable. “o” shown in FIG. 8 represents “passable”, while “x” represents “impassable”.

Note that, as described above, in Example 1, the slippage is modeled using only the topographic shape as the input feature, however, in the case where the work vehicle 1 is equipped with an image capturing device such as a camera, image data (e.g., brightness value and texture of the pixels) may be added to the topographic shape as the input data (features) of the model.

Also, since it is highly possible that the motion of the work vehicle 1 in a position near the current position will be close to the motion in the current position, the position where the mobile object state data is obtained may be used as the feature amount. Further, the moving speed, the steering operation amount, changes in the weights and weight balance due to an increase/decrease in the load of the work vehicle 1, passive/active changes in the shape of work vehicle 1 due to the suspension or the like, may be added to the feature amount.

Although Example 1 described the slippage, vibration of the work vehicle 1 is another example of motion that is to be estimated. The basic process flow is similar to the above-described case of the slippage. In the case of vibration, however, time-series information of the acceleration measured by the IMU is transformed into the magnitude and frequency of the vibration by the Fourier transformation, and the transformed values are modeled as the function related to the topographic shape.

Further, other examples of the motion to be estimated include the power consumption, the fuel consumption, and the vehicle attitude angle. The basic flow of leaning and estimation of those motions are similar to the above-described case of the slippage.

The power consumption and fuel consumption are modeled using the measurement value of the corresponding measuring instrument and data regarding the topographic shape.

In many cases, the attitude angle is substantially the same as the inclination angle of the ground. However, depending on the geological characteristics and the degree of unevenness of the ground, the vehicle body may tilt at an angle larger than the ground inclination angle and enter a dangerous state. In view of this, for example, the attitude angle is modeled as a function expressing the topographic shape of the target environment, using the topographic shape estimated from the point clouds measured in advance by the LiDAR, and the attitude angle of the vehicle (attitude angle of the vehicle calculated using the angular velocity measured by the IMU) when actually traveling on the topography, as a pair of input/output data.

### EXAMPLE 2

In Example 2, a method for planning a path and controlling movement of the mobile object in an unknown environment will be described. Specifically, in Example 2, the path is obtained based on the estimation result obtained in Example 1, and the mobile object is moved according to the obtained path.

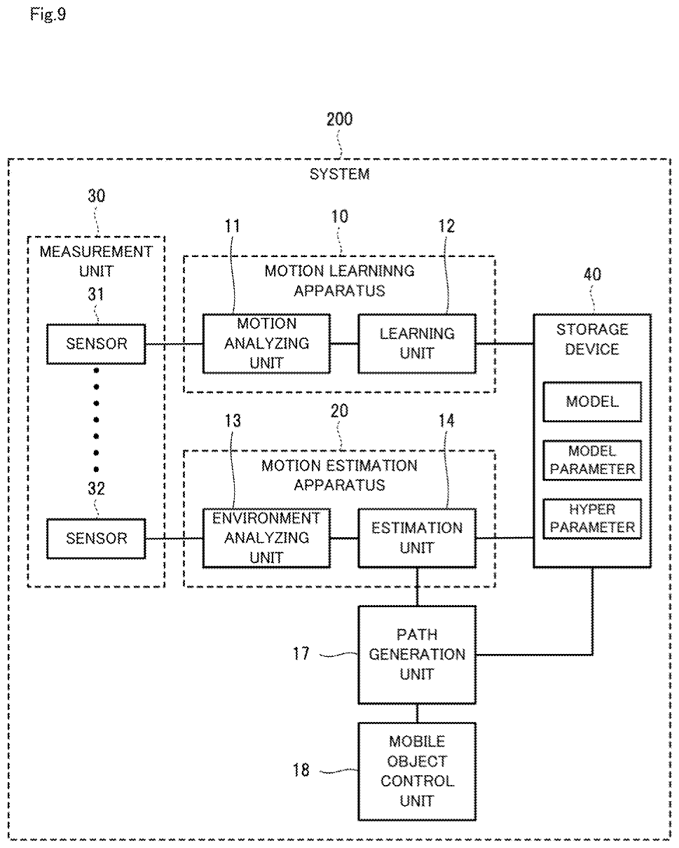

FIG. 9 is a diagram illustrating the system of Example 2. As shown in FIG. 9, a system 200 of Example 2 includes the motion learning apparatus 10, the motion estimation apparatus 20, the measurement unit 30, the storage device 40, a path generation unit 17, and a mobile object control unit 18.

### System configuration of Example 2

Since the motion learning apparatus 10, the motion estimation apparatus 20, the measurement unit 30, and the storage device 40 have already been described, description thereof will be omitted here.

The path generation unit 17 generates path data indicating the route from the current position to the target site, based on the result of estimation of the motion of the mobile object in the target environment (motion estimation result data).

Specifically, first, the path generation unit 17 obtains the motion estimation result data of the mobile object in the target environment as shown in FIGS. 7 and 8, from the estimation unit 14. Next, the path generation unit 17 generates the path data by applying general path planning processing to the motion estimation result data. Next, the path generation unit 17 outputs the path data to the mobile object control unit 18.

The mobile object control unit 18 controls and moves the mobile object based on the motion estimation result data and the path data.

Specifically, first, the mobile object control unit 18 obtains the motion estimation result data and the path data. Next, the mobile object control unit 18 generates information for controlling the units related to movement of the mobile object, based on the motion estimation result data and the path data. Then, the mobile object control unit 18 controls the mobile object to move from the current position to the target site.

Note that, the path generation unit 17 and the mobile object control unit 18 may be provided inside the motion estimation apparatus 20.

An example will be described in which a path of the work vehicle 1 from the current position to the target location is planned based on the estimation of the slippage by the estimation unit 14.

The larger the value of slippage is, not only the lower the movement efficiency of the work vehicle 1, but also the possibility is higher that the work vehicle 1 will become immobilized and unable to move due to being stuck in the ground. In view of this, the path is generated such that the locations corresponding to grid cells that are estimated to have high values of slippage are avoided.

A case of planning a path will be described using an example in which whether the location is passable or impassable is determined from the slippage estimated based on the maximum inclination angle shown in FIG. 8.

Here, any algorithm may be used to plan the path. For example, the generally-used A* (A-star) algorithm is used. In the A* algorithm, the nodes adjacent to the current location are sequentially searched, and the route is efficiently searched based on the movement cost between the current search node and the adjacent search node and the movement cost from the adjacent node to the target location.

Also, the central position for each grid cell (coordinates) is assumed to be one node, and movement is possible from each node to the adjacent nodes that are in sixteen directions. The movement cost is assumed to be the Euclidean distance between the nodes.

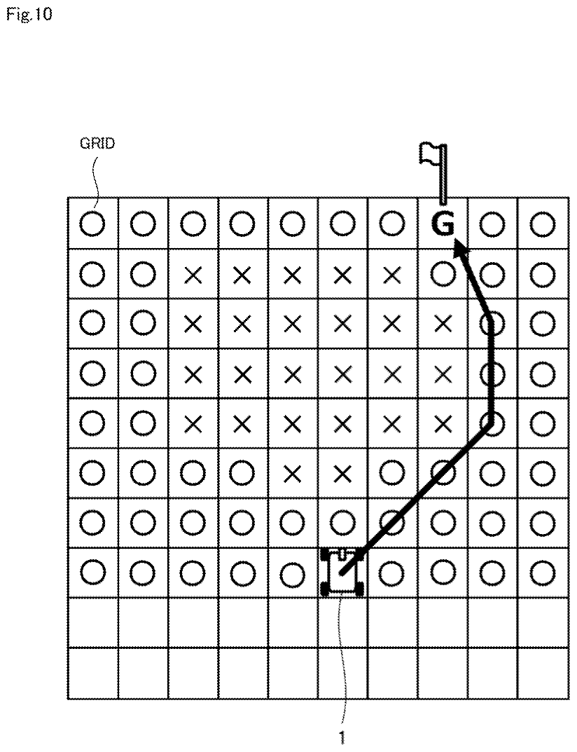

In the case where the node is determined to be passable, the path is searched on the assumption that the movement from another node to that node is possible. As a result, the path from the current location to the target location G (solid arrow in FIG. 10) as shown in FIG. 10 is generated. FIG. 10 is a diagram illustrating an example of a path.

Note that the path generation unit 17 outputs information indicating a series of nodes on the path to the mobile object control unit 18.

Also, in actuality, the path generation unit 17 generates the path including the orientation of the work vehicle 1 in addition to the position of the work vehicle 1. This is because the movement direction of the work vehicle 1 is restricted, due, for example, to the work vehicle 1 not being able to move laterally, and there being a restriction on the steering angle. Thus, the orientation of the vehicle needs to be considered as well.

Next, a case of planning a path will be described using an example in which the continuous slippage shown in FIG. 7 is assigned to the grid cells will be described.

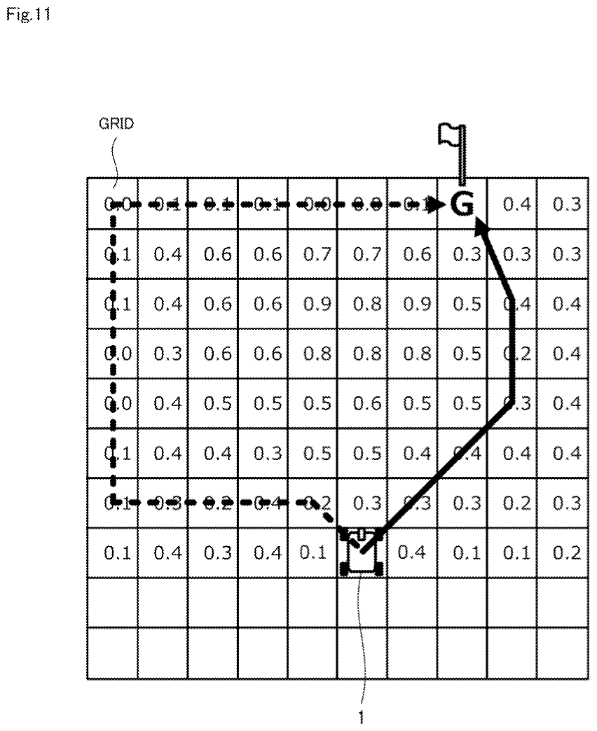

Here, the central position (coordinates) of each grid cell is assumed to be one node, and movement is possible from each node to the adjacent nodes that are in sixteen directions. Since the movement cost reflects the estimated slippage in the route search, the movement cost between the nodes is assumed to be the total weight of the distance and slippage shown in Expression 5, rather than merely the Euclidean distance, for example. FIG. 11 is a diagram illustrating one example of a path.

[Expression 5]

Cost=a*L+b*Slip
Cost: Movement cost between nodes
L: Euclidean distance
Slip: Slippage
a and b: Weight used to generate path (value greater than or equal to 0)

In the example in FIG. 11, if the weight a is set larger than a weight b, the path (solid arrow in FIG. 11) having a relatively short Euclidean distance L is generated. In contrast to this, if the weight b is set larger than the weight a, a path (broken arrow in FIG. 11) that has a long Euclidean distance but avoids the nodes with a high slippage value is generated.

Note that, in the case where it is possible to express the estimation considering the uncertainty as well by Gaussian process regression or the like, in other words, in the case where the mean value and the variance value of the slippage are estimated for each grid cell, a path is generated such that grid cells having a large distribution value (uncertainty of estimation) are avoided even if the mean value is small.

### Apparatus Operations

Next, the operations of the motion learning apparatus 10, the motion estimation apparatus 20, the systems 100 and 200 according to the example embodiment, Example 1, and Example 2 of the invention will be described using the drawings.

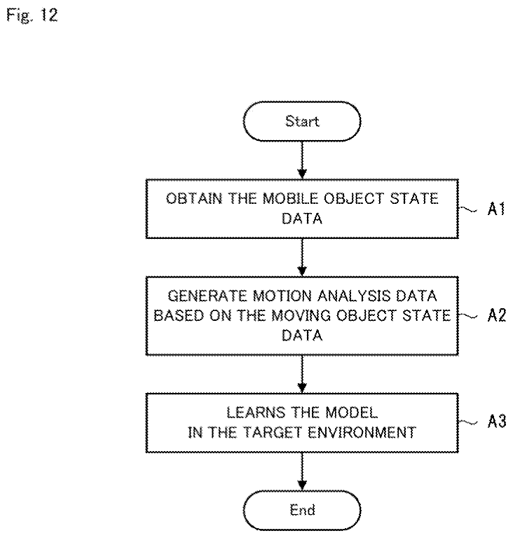

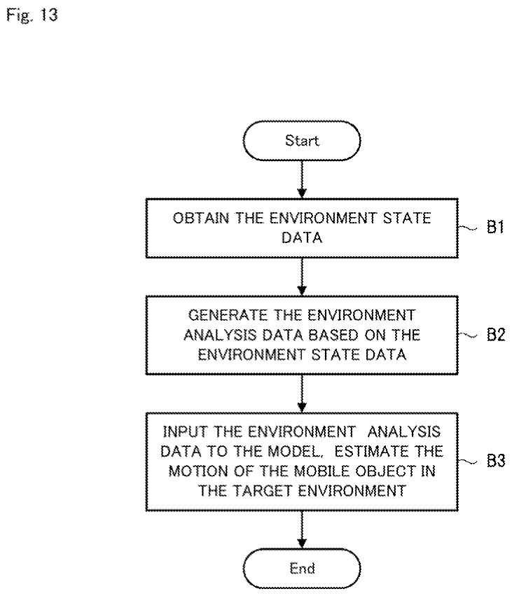

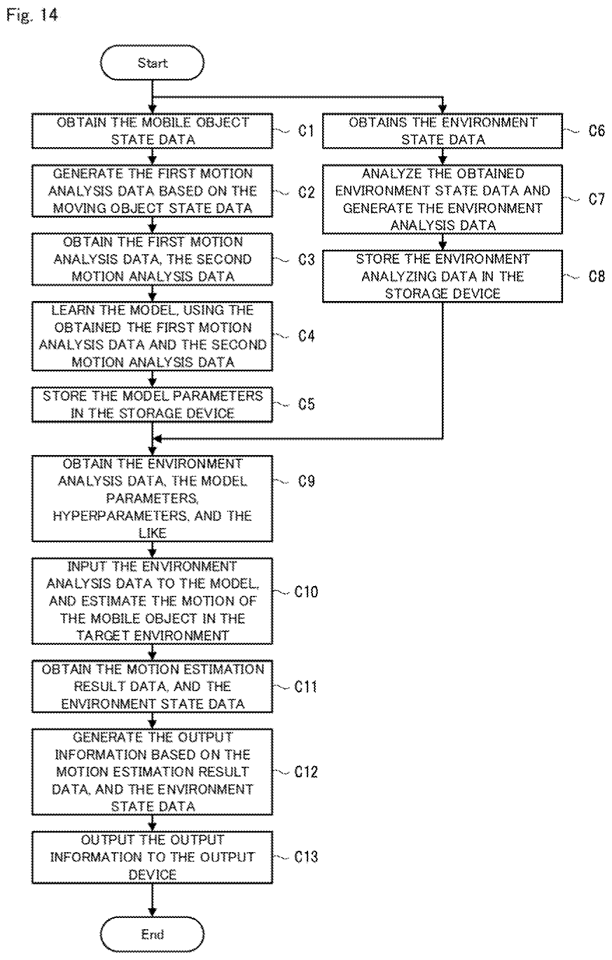

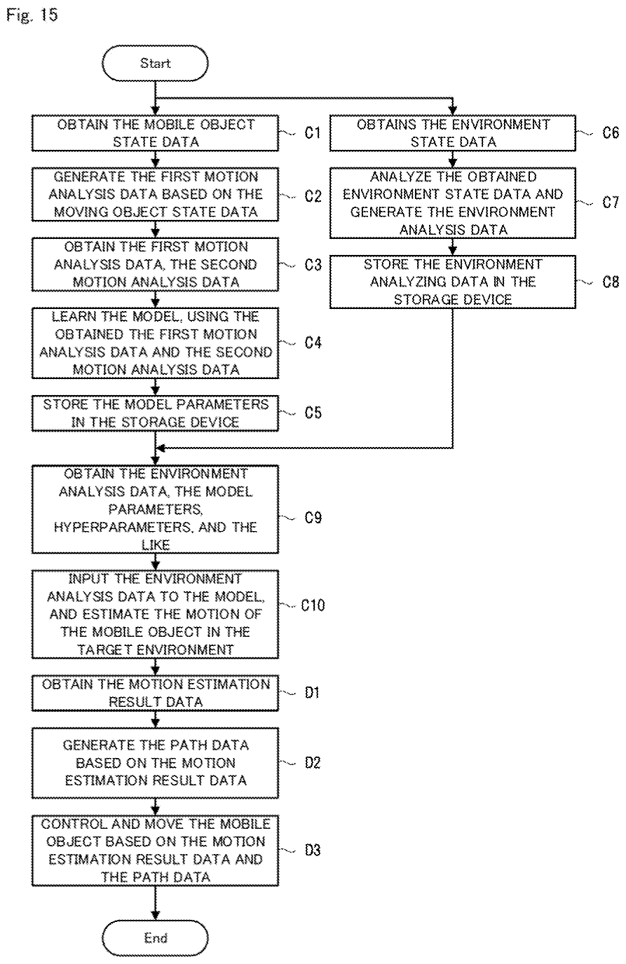

FIG. 12 is a diagram illustrating an example of the operations of the motion learning apparatus. FIG. 13 is a diagram illustrating an example of the operations of the motion estimation apparatus. FIG. 14 is a diagram illustrating an example of the operations of the system of Example 1. FIG. 15 is a diagram illustrating an example of the operations of the system of Example 2.

In the following description, the drawings will be referred to as appropriate. Furthermore, in the example embodiment, Example 1, and Example 2, the motion learning method, the motion estimation method, the display method, and the mobile object control method are implemented by causing the motion learning apparatus 10, the motion estimation apparatus 20, and the systems 100 and 200 to operate. Accordingly, the descriptions of the motion learning method, the motion estimation method, the display method, and the mobile object control method according to the example embodiment, Example 1, and Example 2 are substituted for the following descriptions of the operations of the motion learning apparatus 10, the motion estimation apparatus 20, and the systems 100 and 200.

### Operations of Motion Learning Apparatus

As shown in FIG. 12, first, the motion analyzing unit 11 obtains the mobile object state data from the sensors 31 (step A1). Next, the motion analyzing unit 11 analyzes the motion of the mobile object based on the mobile object state data indicating the state of the mobile object, and generates the motion analysis data indicating the motion of the mobile object (step A2).

Next, the learning unit 12 learns the model for estimating the motion of the mobile object in the target environment, using the first motion analysis data generated in the target environment and the second motion analysis data generated for each known environment of the respective known environments in the past (step A3).

### Operations of Motion Estimation Apparatus

As shown in FIG. 13, first, the environment analyzing unit 13 obtains the environment state data from the sensors 32 (step B1). Next, the environment analyzing unit 13 analyzes the target environment based on the environment state data indicating the state of the target environment, and generates the environment analysis data (step B2).

Next, the estimation unit 14 inputs the environment analysis data to the model for estimating the motion of the mobile object in the target environment, and estimates the motion of the mobile object in the target environment (step B3).

### Operations of System (Display Method)

As shown in FIG. 14, the sensors 31 measure the state of the mobile object and output the measured mobile object state data to the motion analyzing unit 11. Also, the sensors 32 measure the surrounding environment of the mobile object (target environment) and output the measured environment state data to the environment analyzing unit 13.

First, the motion analyzing unit 11 obtains the mobile object state data measured by each of the sensors included in the sensors 31 in the target environment (step C1). Next, the motion analyzing unit 11 analyzes the obtained mobile object state data and generates the first motion analysis data indicating the motion of the mobile object (step C2). Next, the motion analyzing unit 11 outputs the generated first motion analysis data to the learning unit 12.

First, the learning unit 12 obtains the first motion analysis data that is output from the motion analyzing unit 11, and the second motion analysis data generated in respective known environments stored in the storage device 40 (step C3). Next, the learning unit 12 learns the models represented by Expressions 2, 3, and the like, using the obtained first motion analysis data and the second motion analysis data (step C4). Next, the learning unit 12 stores the model parameters generated through the learning in the storage device 40 (step C5).

First, the environment analyzing unit 13 obtains the environment state data measured by each of the sensors included in the sensors 32 in the target environment (step C6). Next, the environment analyzing unit 13 analyzes the obtained environment state data and generates the environment analysis data indicating the state of the environment (step C7). Next, the environment analyzing unit 13 outputs the generated environment analysis data to the estimation unit 14. Next, the environment analyzing unit 13 stores the environment analyzing data generated through the analysis in the storage device 40 (step C8).

First, the estimation unit 14 obtains the environment analysis data that is output from the environment analyzing unit 13, the model parameters, hyperparameters, and the like stored in the storage device 40 (step C9). Next, the estimation unit 14 inputs the obtained environment analysis data, the model parameters, the hyperparameters, and the like, to the model for estimating the motion of the mobile object in the target environment, and estimates the motion of the mobile object in the target environment (step C10). Next, the estimation unit 14 outputs the motion estimation result data to the output information generation unit 15.

First, the output information generation unit 15 obtains the motion estimation result data that is output from the estimation unit 14 and the environment state data from the storage device 40 (step C11). Next, the output information generation unit 15 generates the output information that is to be output to the output device 16, based on the motion estimation result data and the environment state data (step C12). The output information generation unit 15 outputs the output information to the output device 16 (step C13).

The output information is, for example, information used to display the image, the map, and the like of the target environment on the monitor of the output device 16. Note that, the motion of the mobile object, risk of the target environment, whether the mobile object can move, and the like may be displayed on the image and the map of the target environment, based on the estimation result.

The output device 16 obtains the output information generated by the output information generation unit 15 and outputs the image, audio, and the like, based on the obtained output information.

### System Operations (Mobile Object Control Method)

As shown in FIG. 15, the processing of steps C1 to C10 is performed. Next, the path generation unit 17 first obtains the motion estimation result data from the estimation unit 14 (step D1). Next, the path generation unit 17 generates the path data indicating the path from the current position to the target site based on the motion estimation result data (step D2).

Specifically, in step D1, the path generation unit 17 obtains the motion estimation result data of the mobile object in the target environment as shown in FIGS. 7 and 8, from the estimation unit 14. Next, in step D2, the path generation unit 17 generates the path data by applying general path planning processing on the motion estimation result data of the mobile object. Next, the path generation unit 17 outputs the path data to the mobile object control unit 18.

The mobile object control unit 18 controls and moves the mobile object based on the motion estimation result data and the path data (step D3).

Specifically, in step D3, first, the mobile object control unit 18 obtains the motion estimation result data and the path data. Next, the mobile object control unit 18 generates information for controlling the units related to the movement of the mobile object based on the motion estimation result data and the path data. Then, the mobile object control unit 18 controls and moves the mobile object from the current location to the target location.

### Effects of Example Embodiment

As described above, according to the example embodiment, Example 1, and Example 2, motion of the mobile object can be accurately estimated in an unknown environment. Accordingly, the mobile object can be accurately controlled even in an unknown environment.

### Program

The program according to the example embodiment, Example 1, and Example 2 may be a program that causes a computer to execute steps A1 to A3, steps B1 to B3, steps C1 to C13, steps D1 to D3 shown in FIGS. 12 to 15. By installing this program in a computer and executing the program, the motion learning apparatus 10, the motion estimation apparatus 20, the systems 100 and 200, and their methods in the example embodiment, example 1, and example 2 can be realized. In this case, the processor of the computer performs processing to function as the motion analyzing unit 11, the learning unit 12, the environment analyzing unit 13 the estimation unit 14, the output information generation unit 15, the path generation unit 17, and the mobile object control unit 18.

Also, the program according to the example embodiment, Example 1, and Example 2 may be executed by a computer system constructed by a plurality of computers. In this case, for example, each computer may function as any of the motion analyzing unit 11, the learning unit 12, the environment analyzing unit 13 the estimation unit 14, the output information generation unit 15, the path generation unit 17, and the mobile object control unit 18.

### Physical Configuration

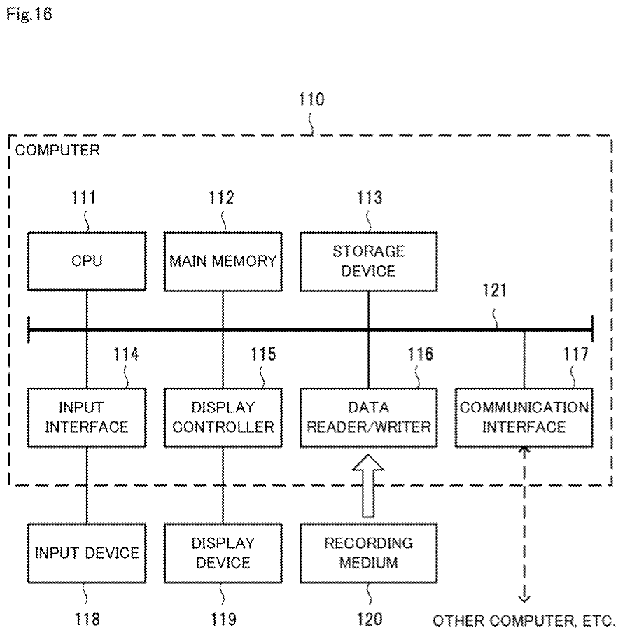

Here, a computer that realizes the motion learning apparatus 10, the motion estimation apparatus 20, the systems 100 and 200 by executing the program according to the example embodiment, Example 1, and Example 2 will be described with reference to FIG. 16. FIG. 16 is a block diagram showing an example of a computer that realizes the motion learning apparatus and the motion estimation apparatus.

As shown in FIG. 16, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the motion learning apparatus 10, the motion estimation apparatus 20, the systems 100 and 200 according to the example embodiment, Example 1, and Example 2 can also be realized by using hardware corresponding to each unit. Furthermore, a portion of the motion learning apparatus 10, the motion estimation apparatus 20, the systems 100 and 200 may be realized by a program, and the remaining portion realized by hardware.

### Supplementary Notes

Furthermore, the following supplementary notes are disclosed regarding the example embodiments described above. Some portion or all of the example embodiments described above can be realized according to (supplementary note 1) to (supplementary note 15) described below, but the below description does not limit the invention.

### Supplementary Note 1

A motion learning apparatus comprising:
a motion analyzing unit configured to analyze motion of a mobile object based on mobile object state data indicating a state of the mobile object, and generating motion analysis data indicating the motion of the mobile object; and
a learning unit configured to learn a model for estimating the motion of the mobile object in a first environment, using first motion analysis data generated in the first environment and second motion analysis data generated in respective second environments.

### Supplementary Note 2

A motion estimation apparatus comprising:
an environment analyzing unit configured to analyze a first environment based on environment state data indicating a state of the first environment, and generating environment analysis data, and
an estimation unit configured to estimate motion of a mobile object in the first environment by inputting the environment analysis data to a model for estimating the motion of the mobile object in the first environment.

### Supplementary Note 3

The motion estimation apparatus according to Supplementary Note 2, further comprising:
a motion analyzing unit configured to analyze the motion of the mobile object based on mobile object state data indicating a state of the mobile object, and generating motion analysis data indicating the motion of the mobile object; and
a learning unit configured to learn the model for estimating the motion of the mobile object in the first environment, using first motion analysis data generated in the first environment and second motion analysis data generated in respective second environments.

### Supplementary Note 4

The motion estimation apparatus according to Supplementary Note 2 or 3, further comprising:
a path generation unit configured to generate path data indicating a path from a current location to a target site based on motion estimation result data that is a result of estimating the motion of the mobile object in the first environment; and
a mobile object control unit configured to control and making the mobile object move based on the motion estimation result data and the path data.

### Supplementary Note 5

The motion estimation apparatus according to Supplementary Note 2 or 3, further comprising:
an output information generation unit configured to generate output information to be output to an output device, based on motion estimation result data that is a result of estimation of the motion of the mobile object in the first environment and the environment state data.

### Supplementary Note 6

A motion learning method, comprising:
a motion analyzing step of analyzing motion of a mobile object based on mobile object state data indicating a state of the mobile object and generating motion analysis data indicating the motion of the mobile object; and
a learning step of learning a model for estimating the motion of the mobile object in a first environment, using first motion analysis data generated in the first environment and second motion analysis data generated in respective second environments.

### Supplementary Note 7

A motion estimation method, comprising:
an environment analyzing step of analyzing a first environment based on environment state data indicating a state of the first environment, and generating environment analysis data, and
an estimation step of estimating motion of a mobile object in the first environment by inputting the environment analysis data to a model for estimating the motion of the mobile object in the first environment.

### Supplementary Note 8

The motion estimation method according to Supplementary Note 7, further comprising:
a motion analyzing step of analyzing the motion of the mobile object based on mobile object state data indicating a state of the mobile object, and generating the motion analysis data indicating the motion of the mobile object; and
a learning step of learning the model for estimating the motion of the mobile object in the first environment, using first motion analysis data generated in the first environment and second motion analysis data generated in respective second environments.

### Supplementary Note 9

The motion estimation method according to Supplementary Note 7 or 8, further comprising:
a path generation step of generating path data indicating a path from a current location to a target site based on motion estimation result data that is a result of estimating the motion of the mobile object in the first environment; and
a mobile object control step of controlling and making the mobile object move based on the motion estimation result data and the path data.

### Supplementary Note 10

The motion estimation method according to Supplementary Note 7 or 8, further comprising:
an output information generation step generating output information to be output to an output device, based on motion estimation result data that is a result of estimation of the motion of the mobile object in the first environment and the environment state data.

### Supplementary Note 11

A computer-readable recording medium that includes a program recorded thereon, the program including instructions that cause a computer to carry out:
a motion analyzing step of analyzing motion of a mobile object based on mobile object state data indicating a state of the mobile object and generating motion analysis data indicating the motion of the mobile object; and
a learning step of learning a model for estimating the motion of the mobile object in a first environment, using first motion analysis data generated in the first environment and second motion analysis data generated in respective second environments.

### Supplementary Note 12

A computer-readable recording medium that includes a program recorded thereon, the program including instructions that cause a computer to carry out:
an environment analyzing step of analyzing a first environment based on environment state data indicating a state of the first environment, and generating environment analysis data, and
an estimation step of estimating motion of a mobile object in the first environment by inputting the environment analysis data to a model for estimating the motion of the mobile object in the first environment.

### Supplementary Note 13

The computer-readable recording medium according to Supplementary Note 12 including the program recorded thereon, the program further including instructions that cause a computer to carry out:
a motion analyzing step of analyzing the motion of the mobile object based on mobile object state data indicating a state of the mobile object, and generating the motion analysis data indicating the motion of the mobile object; and
a learning step of learning the model for estimating the motion of the mobile object in the first environment, using first motion analysis data generated in the first environment and second motion analysis data generated in respective second environments.

### Supplementary Note 14

The computer-readable recording medium according to Supplementary Note 12 or 13 including the program recorded thereon, the program further including instructions that cause a computer to carry out:
a path generation step of generating path data indicating a path from a current location to a target site based on motion estimation result data that is a result of estimating the motion of the mobile object in the first environment; and
a mobile object control step of controlling and making the mobile object move based on the motion estimation result data and the path data.

### Supplementary Note 15

The computer-readable recording medium according to Supplementary Note 12 or 13 including the program recorded thereon, the program further including instructions that cause a computer to carry out:
an output information generation step generating output information to be output to an output device, based on motion estimation result data that is a result of estimation of the motion of the mobile object in the first environment and the environment state data.

Although the invention of the application has been described above with reference to an example embodiment, the invention is not limited to the example embodiment described above. Various modifications apparent to those skilled in the art can be made to the configurations and details of the invention within the scope of the invention.

### INDUSTRIAL APPLICABILITY

As described above, according to the invention, it is possible to calculate a search route to an object position according to the surrounding environment and a target that is a threat. The invention is useful in fields where it is necessary to estimate the of motion of moving object.

### LIST OF REFERENCE SIGNS

1 Work vehicle
10 Motion learning apparatus
11 Motion analyzing unit
12 Learning unit
13 Environment analyzing unit
14 Estimation unit
15 Output information generation unit
16 Output device
17 Path generation unit
18 Mobile object control unit
20 Motion estimation apparatus
30 Measurement unit
31, 32 Sensors
40 Storage device
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. (canceled)

2. A motion estimation apparatus comprising:
one or more memories storing instructions; and
one or more processors configured to execute the instructions to:
analyze a first environment based on environment state data indicating a state of the first environment, and generating environment analysis data, and
estimate motion of a mobile object in the first environment by inputting the environment analysis data to a model for estimating the motion of the mobile object in the first environment.

3. The motion estimation apparatus according to claim 2, further comprising:
one or more processors is further configured to execute the instructions to,
analyze the motion of the mobile object based on mobile object state data indicating a state of the mobile object, and generate motion analysis data indicating the motion of the mobile object; and
learn the model for estimating the motion of the mobile object in the first environment, using first motion analysis data generated in the first environment and second motion analysis data generated in respective second environments.

4. The motion estimation apparatus according to claim 2, further comprising:
one or more processors is further configured to execute the instructions to,
generate path data indicating a path from a current location to a target site based on motion estimation result data that is a result of estimating the motion of the mobile object in the first environment; and
control and move the mobile object based on the motion estimation result data and the path data.

5. The motion estimation apparatus according to claim 2, further comprising:
one or more processors is further configured to execute the instructions to,
generate output information to be output to an output device, based on motion estimation result data that is a result of estimation of the motion of the mobile object in the first environment and the environment state data.

6. (canceled)

7. A motion estimation method, comprising:
analyzing a first environment based on environment state data indicating a state of the first environment, and generating environment analysis data, and
estimating motion of a mobile object in the first environment by inputting the environment analysis data to a model for estimating the motion of the mobile object in the first environment.

8. The motion estimation method according to claim 7, further comprising:
analyzing the motion of the mobile object based on mobile object state data indicating a state of the mobile object, and generating the motion analysis data indicating the motion of the mobile object; and
learning the model for estimating the motion of the mobile object in the first environment, using first motion analysis data generated in the first environment and second motion analysis data generated in respective second environments.

9. The motion estimation method according to claim 7, further comprising:
generating path data indicating a path from a current location to a target site based on motion estimation result data that is a result of estimating the motion of the mobile object in the first environment; and
controlling and making the mobile object move based on the motion estimation result data and the path data.

10. The motion estimation method according to claim 7, further comprising:
generating output information to be output to an output device, based on motion estimation result data that is a result of estimation of the motion of the mobile object in the first environment and the environment state data.

11. (canceled)

12. A non-transitory computer-readable recording medium that includes a program recorded thereon, the program including instructions that cause a computer to carry out:
estimating motion of a mobile object in the first environment by inputting the environment analysis data to a model for estimating the motion of the mobile object in the first environment.

13. The non-transitory computer-readable recording medium according to claim 12 including the program recorded thereon, the program further including instructions that cause a computer to carry out:
analyzing the motion of the mobile object based on mobile object state data indicating a state of the mobile object, and generating the motion analysis data indicating the motion of the mobile object; and
learning the model for estimating the motion of the mobile object in the first environment, using first motion analysis data generated in the first environment and second motion analysis data generated in respective second environments.

14. The non-transitory computer-readable recording medium according to claim 12 including the program recorded thereon, the program further including instructions that cause a computer to carry out:
generating path data indicating the path from a current location to a target site based on motion estimation result data that is a result of estimating the motion of the mobile object in the first environment; and
controlling and making the mobile object move based on the motion estimation result data and the path data.

15. The non-transitory computer-readable recording medium according to claim 12 including the program recorded thereon, the program further including instructions that cause a computer to carry out:
generating output information to be output to an output device, based on motion estimation result data that is a result of estimation of the motion of the mobile object in the first environment and the environment state data.
